(19) United States
(12) Patent Application Publication
(10) Pub. No.: US 2013/0268476 A1
(43) Pub. Date: Oct. 10, 2013

(54) METHOD AND SYSTEM FOR CLASSIFICATION OF MOVING OBJECTS AND USER AUTHORING OF NEW OBJECT CLASSES

(71) Applicants: Yogesh Sankarasubramniam, Bangalore (IN); Krusheel Munnangi, Bangalore (IN); Anbumani Subramanian, Bangalore (IN); Avinash Sharma, Bangalore (IN); Serene Banerjee, Bangalore (IN)

(72) Inventors: Yogesh Sankarasubramniam, Bangalore (IN); Krusheel Munnangi, Bangalore (IN); Anbumani Subramanian, Bangalore (IN); Avinash Sharma, Bangalore (IN); Serene Banerjee, Bangalore (IN)

(73) Assignee: Hewlett-Packard Development Company, L.P., Houston, TX (US)

(21) Appl. No.: 13/995,121

(22) PCT Filed: Dec. 24, 2010
(86) PCT No.: PCT/IN2010/000852

§ 371 Date: Jun. 17, 2013

(51) Int. Cl. G06N 5/02

(52) U.S. Cl. CPC G06N 5/02
USPC 706/46

(57) ABSTRACT

A system and method for classification of moving objects and user authoring of new object classes is disclosed. In one embodiment, in a method of classification of moving objects, a moving object is inputted. Then, an object descriptor and a motion descriptor are extracted from the inputted moving object. Multiple initial candidate library object descriptors are identified from an object library and a motion library using the extracted object descriptor and the extracted motion descriptor. An initial object class estimate is identified based on the identified multiple initial candidate library object descriptors. Then, an initial residue is computed based on the extracted object descriptor and the identified multiple initial candidate library object descriptors associated with the initial object class estimate. The object class estimates are iteratively identified and it is determined whether the object class estimates converge based on a stopping criterion.

### BACKGROUND

There are many techniques for classification of objects into one of several known object classes. For example, the objects may be moving objects or static objects. Typically, these techniques are parametric and may need large amounts of training data or samples. Some of the parametric techniques include those based on hidden markov models (HMM), support vector machine (SVM) and artificial neural networks (ANN). On the other hand, there exist non-parametric methods like nearest neighbor, but may not be accurate with small amounts of training data. Thus, due to requirement of more number of training samples, the above-mentioned techniques for classification of objects may not be feasible. Further, authoring a new object class may be also cumbersome, as it usually involves re-training entire data.

### BRIEF DESCRIPTION OF THE DRAWINGS

Various embodiments are described herein with reference to the drawings, wherein:

FIG. 1 illustrates a computer-implemented flow diagram of a method of classification of moving objects, according to one embodiment;

FIG. 2 illustrates a computer-implemented flow diagram of a method of user authoring of new object classes, according to one embodiment;

FIG. 3 illustrates classification of hand gestures, according to one embodiment;

FIG. 4 illustrates classification of printed logos in printed documents, according to one embodiment; and

FIG. 5 illustrates an example of a suitable computing system environment for implementing embodiments of the present subject matter.

The drawings described herein are for illustration purposes only and are not intended to limit the scope of the present subject matter in any way.

### DETAILED DESCRIPTION

A system and method for classification of moving objects and user authoring of new object classes is disclosed. In the following detailed description of the embodiments of the present subject matter, reference is made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

In the document, ‘moving object’ refers to a general entity that includes motions of different entities like a continued motion of the left hand followed by a motion of the right hand. A collection of such ‘moving objects’ into which a given test object needs to be classified is referred to as an ‘object class’ in the document. The object class includes variations of the ‘moving objects’.

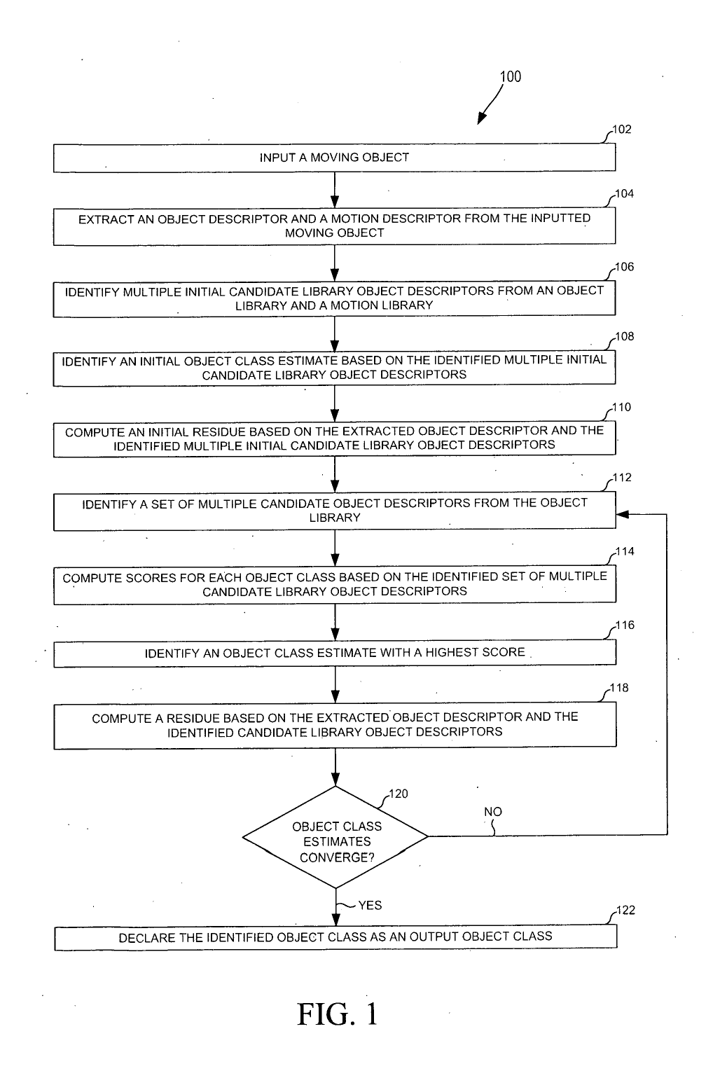

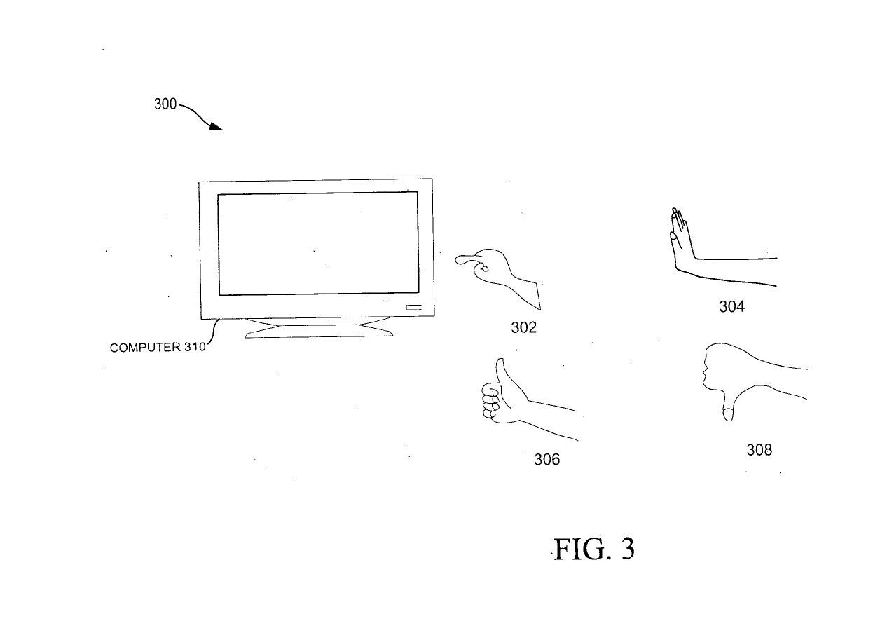

FIG. 1 illustrates a computer-implemented flow diagram 100 of a method of classification of moving objects, according to one embodiment. One example of classification of moving objects is classification of hand gestures in human-computer interaction, described in detail with respect to FIG. 3. At step 102, a moving object is inputted. At step 104, an object descriptor and a motion descriptor are extracted from the inputted moving object. The object descriptor and the motion descriptor include features describing shape, size, color, temperature, motion, and intensity of the inputted moving object.

At step 106, multiple initial candidate library object descriptors are identified from an object library and a motion library using the extracted object descriptor and the extracted motion descriptor. The object library and motion library are formed from given object samples including known object classes. The formation of the object library and the motion library is explained in greater detail in the below description. At step 108, an initial object class estimate is identified based on the identified multiple initial candidate library object descriptors. At step 110, an initial residue is computed based on the extracted object descriptor and the identified multiple initial candidate library object descriptors associated with the initial object class estimate.

At step 112, a set of multiple candidate object descriptors is identified from the object library based on a residue and the identified multiple candidate library object descriptors from a previous iteration. At step 114, scores are computed for each object class based on the identified set of multiple candidate library object descriptors. At step 116, an object class estimate with a highest score is identified. At step 118, a residue is computed based on the extracted object descriptor and the identified candidate library object descriptors associated with the identified object class estimate. At step 120, it is determined whether the identified object class estimates converge based on a stopping criterion. If it is determined so, step 122 is performed, else the method is routed to perform the step 112.

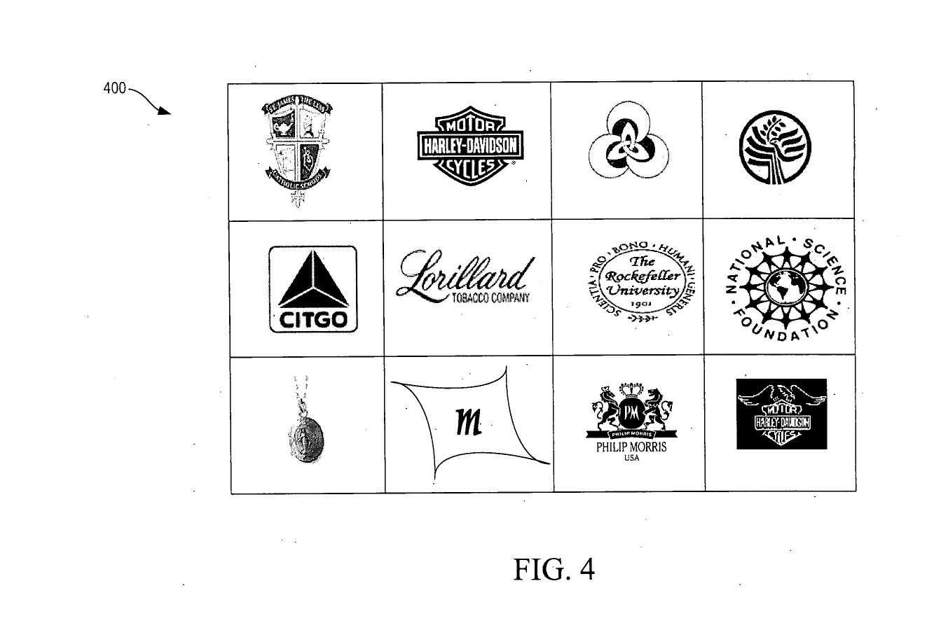

At step 122, the identified object class is declared as an output object class. In one example implementation, if it is determined in step 120 that the identified object class estimates converge based on the stopping criterion, it is determined whether to reject the inputted moving object based on an object rejection criterion. Further, if the inputted object is not to be rejected, step 122 is performed. According to one embodiment of the present subject matter, a method of classification of a static object may be also realized in a similar manner as the method described above. One example of classification of static objects is recognition of logos from printed documents which is explained in detail with respect to FIG. 4. Example pseudocodes and pseudocode details for classification of moving objects and static objects are given in APPENDIXES A and B, respectively.

The object library and the motion library may be formed as below. Consider a set of N object classes labeled 1, 2, 3 . . . N. Each of the object classes includes a small set of representative samples. For example, the samples may be a set of short videos of the moving object. Within each sample, a relevant portion is first identified which includes the moving object. This may be done, for example in videos, by identifying a start frame and an end frame using any suitable object detection and segmentation. The identification of the start frame and the end frame removes extraneous data not needed for classification.

Then, an object class library L; is formed for each object class i. The object class library L; includes two sub-libraries, namely object library L_{o,i} and motion library L_{m,i}. The object library L_{o,i} and motion library L_{m,i} includes object descriptors and motion descriptors, respectively. The object library L_{o,i} for a given object class i is formed by extracting suitable object descriptors from given samples of the object class i. For example, an object descriptor is extracted from each sample of the object class i and then the object descriptors are concatenated to form the object library L_{o,i}.

For, example, if the given samples of the object class i are short videos, few frames are selected from the given video samples, and object feature vectors are computed for the selected frames. The frame selection may be performed by sampling to capture enough representative object feature vectors. For example, the object feature vectors may be features describing shape, size, color, temperature, motion, intensity of the object, and the like. The object descriptor is then formed by concatenating the object feature vectors columnwise.

The above process is then repeated for each video sample and the object descriptors from each of the video samples are concatenated to form the object library L_{o,i} for a given object class i. Mathematically, the object library L_{o,i} is represented as L_{o,i}=[L_{o,i,1}L_{o,i,2}L_{o,i,3} . . . L_{o,i,M}_{_{—}}ᵢ] for Mᵢ samples in object class i, where each object descriptor L_{o,i,k} is further written as a concatenation of length-F feature vectors as L_{o,i,k}=[l_{o,i,k,1}l_{o,i,k,2} . . . ]. The size of the object library L_{o,l} can be reduced using techniques such as clustering, singular value decomposition (SVD) and the like. For example, in K-means clustering, each cluster corresponds to a variation of a hand gesture in FIG. 3. One representative sample from each cluster may then be chosen to be part of the object library L_{o,l}.

The full object Library Lₒ for the N object classes is obtained by further concatenating the individual object libraries. Thus, Lₒ=[L_{o,1}L_{o,2}L_{o,3} . . . L_{o,N}], where L_{o,i} denotes the object library for object class i, which is formed as explained above. The number of rows in Lₒ is F, while the number of columns depends on the total number of samples. Thus, Lₒ is composed of M₁+M₂+ . . . +M_{N} object descriptors.

Similarly, the motion library Lₘ=[L_{m,1}L_{m,2}L_{m,3} . . . L_{m,N}], where L_{m,i} denotes the motion library for object class i. For each object sample, a motion descriptor may be formed for that sample. Then the motion descriptors may be stacked from each of the object samples to form the motion library L_{m,i}. Thus, L_{m,i} can be written as L_{m,i}=[l_{m,i,1}l_{m,i,2} . . . l_{m,i,M}_{_{—}}ᵢ]. The motion descriptors for object samples may not have same length, unlike the feature vectors. For example, if the given object class samples are short videos, motion vector of a centroid of the object is calculated from one frame to another, from a start frame to an end frame. Then, an angle which the motion vectors make with a positive x-axis is determined for every frame. The angle vectors of each object sample are stacked to obtain the motion library L_{m,i}.

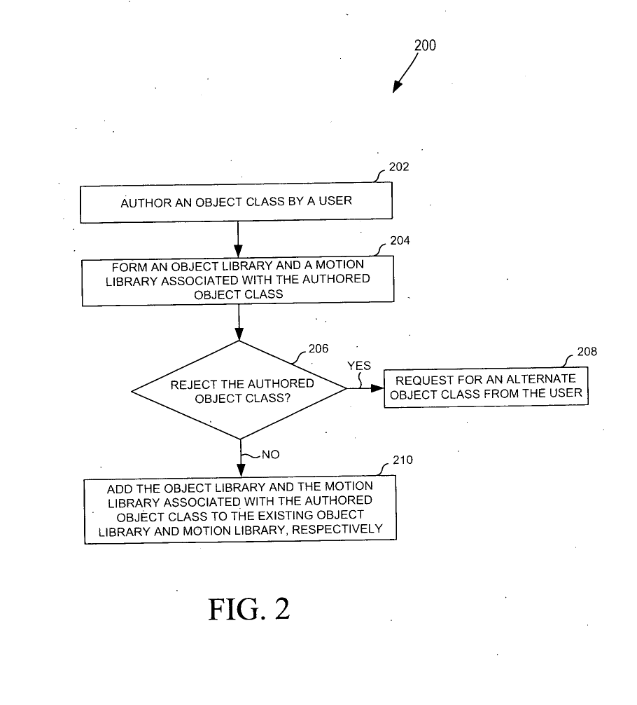

FIG. 2 illustrates a computer-implemented flow diagram 200 of a method of user authoring of new object classes, according to one embodiment. At step 202, an object class is authored by a user. For example, the user may provide representative samples of a chosen object class. In case of a new hand gesture, demonstrations of the new hand gesture may be provided by the user. At step 204, object library and motion library associated with the authored object class by the user are formed, which is similar to the method of formation of libraries described above. The clustering and the SVD techniques may be used to reduce the size of the object library for the user-authored object class.

At step 206, it is determined whether to reject the authored object class. For example, it may be determined whether the object library and the motion library associated with the authored object class are substantially close to the existing object library and the motion library using an object rejection criterion. If it is determined so, the authored object class is rejected and the user is requested for an alternate object class in step 208. If not, step 210 is performed where the object library and the motion library associated with the authored object class are added to the existing object library and motion library, respectively.

FIG. 3 illustrates classification of hand gestures, according to one embodiment. The hand gesture classification is one example implementation of a method of classification of moving objects which is described in detail with respect to FIG. 1. As illustrated in FIG. 3, the hand gestures include different hand poses, for example pointing 302, open palm 304, thumb up 306, and thumb down 308. In one example, six hand gestures may be classified, including move right with open palm, move left with open palm, move right with pointing palm, move left with pointing palm, move up with pointing palm, move down with pointing palm. The number of samples used for the six hand gestures are 6, 7, 9, 7, 6, and 6 respectively. The feature vectors are obtained by downsampling and rasterizing a hand region of the captured image frames. User-authored hand gestures may further be added to the above six hand gestures,

FIG. 4 illustrates classification of printed logos in printed documents, according to one embodiment. The classification of printed logos in printed documents is one example implementation of a method of classification of static objects which is similar to the method of classification of moving objects described in detail with respect to FIG. 1. As shown, FIG. 4 includes 12 different logos represented by a library of size 240×119, with around 10 samples per logo. The feature vector is obtained by extracting significant points from the logos and computing a log-polar histogram. Invalid logos are rejected using a threshold-based rejection rule. User-authored logos may further be added to the above 12 logos.

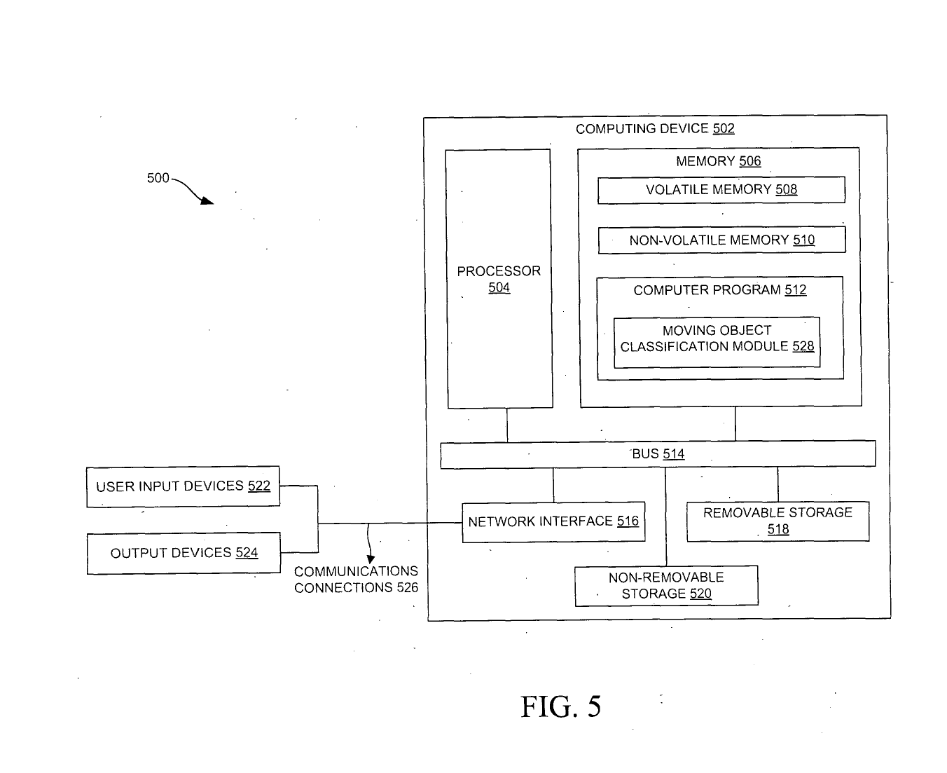

FIG. 5 shows an example of a suitable computing system environment 500 for implementing embodiments of the present subject matter. FIG. 5 and the following discussion are intended to provide a brief, general description of a suitable computing environment in which certain embodiments of the inventive concepts contained herein may be implemented.

A general computing device 502, in the form of a personal computer or a mobile device may include a processor 504, memory 506, a removable storage 518, and a non-removable storage 520. The computing device 502 additionally includes a bus 514 and a network interface 516. The computing device 502 may include or have access to the computing system environment 500 that includes user input devices 522, output devices 524, and communication connections 526 such as a network interface card or a universal serial bus connection.

The user input devices 522 may be a digitizer screen and a stylus, trackball, keyboard, keypad, mouse, and the like. The output devices 524 may be a display device of the personal computer or the mobile device. The communication connections 526 may include a local area network, a wide area network, and/or other networks.

The memory 506 may include volatile memory 508 and non-volatile memory 510. A variety of computer-readable storage media may be stored in and accessed from the memory elements of the computing device 502, such as the volatile memory 508 and the non-volatile memory 510, the removable storage 518 and the non-removable storage 520. Computer memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, and the like.

The processor 504, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 504 may also include embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, and application programs, for performing tasks, or defining abstract data types or low-level hardware contexts. Machine-readable instructions stored on any of the above-mentioned storage media may be executable by the processor 504 of the computing device 502. For example, a computer program 512 may include machine-readable instructions capable of classification of moving objects and user authoring of new object classes, according to the teachings and herein described embodiments of the present subject matter. In one embodiment, the computer program 512 may be included on a compact disk-read only memory (CD-ROM) and loaded from the CD-ROM to a hard drive in the non-volatile memory 510. The machine-readable instructions may cause the computing device 502 to encode according to the various embodiments of the present subject matter.

As shown, the computer program 512 includes a moving object classification module 528. For example, the moving object classification module 528 may be in the form of instructions stored on a non-transitory computer-readable storage medium. The non-transitory computer-readable storage medium having the instructions that, when executed by the computing device 502, may cause the computing device 502 to perform the methods described in FIGS. 1 through 5.

In various embodiments, the methods and systems described in FIGS. 1 through 5 may enable classification of moving or static objects using a small library of samples. The library may be stored on client itself, with few samples per class needed. The above-described method of classification is for real-time classification, where the object classes may include variations of objects. The above-described method of classification is also capable of rejecting test objects which do not belong to any known class. Given the small library needed per class, the above-described method of classification is scalable and supports easy addition or removal of new object classes by a user.

Although the present embodiments have been described with reference to specific examples, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

### APPENDIX A

Moving Object Classification

```
  Input:
Lₒ and Lₘ: Object Library and motion Library of known object classes
N: Number of object classes, labeled 1, 2, . . . , N
Lₒ and lₘ: Object descriptor and motion descriptor of test object
T₁, T₂: Truncation Parameters
τ₁, τ₂: Thresholds
T: Number of iterations
  Initialize:
I⁰: set of T₁ object descriptor indices of Lₒ chosen based on ƒ(Lₒ, Lₘ, Lₒ, lₘ)
Iᵢ⁰: set of indices in I⁰ corresponding to class i, i = 1, 2, . . . , N
Initial object class estimate C⁰ = arg maxᵢΣⱼ₌₁^{M}∥L₁_{ᵢ}_{⁰}xᵢⱼ∥₂, where xᵢⱼ = L [symbol]
Initialize residues rⱼ⁰ = l_{o,j} − L₁_{_{c}}^{₀}_{⁰} x_{C}_{^{o}}ⱼ, j = 1, 2, . . . , M
  Iterate:
for t = 1 to T
Compute Iᵣₑₛ^{t-1}: set of T₂ object descriptor indices of Lₒ chosen
based on h(Lₒ, R^{t-1}), where R^{t-1} = [r₁^{t-1} r₂^{t-1} . . . r_{M}^{t-1}]
Merge I_{new}^{t} = I_{C}_{^{t−1}}^{^{t−1}} ∪ Iᵣₑₛ^{t-1}
Compute I^{t}: set of T₁ object descriptor indices of Lₒ chosen based
on Σⱼ₌₁^{M} |L [symbol]  l_{o,j}|
Compute Iᵢ^{t}: set of indices in I^{t} corresponding to class i
Compute class scores s^{t}(i) = Σⱼ₌₁^{M}∥L_{I}_{ⁱ}_{ₜ}xᵢⱼ∥₂ for each object class
i = 1, 2, . . . , N, where xᵢⱼ = L [symbol]  l_{o,j}
Object class estimate C [symbol]  = arg maxᵢ Σⱼ₌₁^{M}∥L_{I}_{ⁱ}_{ₜ}xᵢⱼ∥₂
Compute residue rⱼ^{t} = l_{o,j} − L [symbol]  , j = 1, 2, . . . , M
Check stopping criteria
end for
  Stopping criteria:
$If \\ ( \begin{matrix}{C}^{t} = {C}^{t - 1} AND \\ {‖ {r}_{j}^{t} ‖}_{2} \leq {‖ {r}_{j}^{t - 1} ‖}_{2} ∀ j AND \\ \frac{{\sum }_{i = 1}^{N} \vert {s}^{t} ( i ) - {s}^{t - 1} ( i ) \vert}{{\sum }_{i = 1}^{N} \vert {s}^{t - 1} ( i ) \vert} < {T}_{1}\end{matrix} )$ $OR$ $t = T ,$
then check object rejection criterion
else go to iteration step 1
  Object rejection criterion:
If g(s^{t}, I^{t}, Lₒ, Lₘ, Lₒ, lₘ) < τ₂ , where s^{t} = (s^{t}(1), s^{t}(2), . . . , s^{t}(N))
then reject test object
else output class C^{t} and stop [symbol]
indicates data missing or illegible when filed
```

### Moving Object Classification Pseudocode Details

1. One possible realization of f (Lₒ, Lₘ, Lₒ, lₘ) is to compute the sum of the projection of the columns of Lₒ in the vector space spanned by the object descriptors, namely L_{o,i,k} for k^{th} sample of class i, multiplied by the longest common subsequence matching index (LCSind) between the test motion descriptor lₘ and the corresponding Library sample motion descriptor, which is given by the following equation

$$( {\sum }_{j = 1}^{M} \vert \vert {L}_{o , i , {k}_{i}}^{†} {I}_{o , j} {\vert \vert}_{2} ) . LC Sin d ( {I}_{m} . {I}_{m , i , {k}_{i}} ) . 1 \leq i \leq N , 1 \leq k \leq {M}_{i}$$

and then selecting the object descriptor indices of Lₒ corresponding to the largest values. The corresponding object descriptors stacked together are now denoted as Lₗ, where we drop the subscript ‘o’ for convenience, and l is used here to denote the appropriate set of indices referred to. Further Lₗ^{†} denotes the pseudoinverse of Lₗ. Other suitable realizations of f (Lₒ, Lₘ, Lₒ, lₘ) may also be possible, including matrix-based computations or using dynamic time warping (DTW) for example.
2. Truncation parameters T₁ and T₂ are chosen appropriately depending on the application and Libraries Lₒ, Lₘ
3. One possible realization of h(.) is to compute the sum of projections of each column of R^{t-1} in the plane of each object descriptor L_{o,i,k} for k^{th} sample of class i. Other realizations may also be possible including matrix-based computations, for example.
4. One possible method of selecting l^{t} is to choose the object descriptor indices corresponding to the largest amplitudes in the given summation.
5. Next, among the identified object descriptors in l^{t}, only those that belong to a particular class are considered, and a score is computed for each class. The class with the highest score is declared as the current class estimate.
6. If there is no convergence behavior among the class estimates at successive iterations, and if the number of iterations t<T, the iterations are continued. Note that only one possible convergence requirement is outlined in the stopping criteria given in the pseudocode, and any other suitable criteria are equally applicable.
7. When t=T iterations or there is convergence, the test object is checked if it should be rejected. This is done using the object rejection criterion. If the object is not to be rejected, then the current class is declared as the output. One possible implementation of the rejection criterion g(.) is a simple threshold based rejection. Other suitable rejection criteria are equally applicable. For example, one could carry out further iterations with different truncation parameters.
   The proposed method may be extended to cover cases where there are multiple observations of the moving test object (say, using multiple cameras); or multiple samples of a given test object; or the case with multiple object libraries and motion libraries.

### APPENDIX B

Static Object Classification

```
  Input:
L: Library of known object classes
N: Number of object classes, labeled 1, 2, . . . , N
l: Feature vector describing test object
T₁, T₂: Truncation Parameters
τ₁, τ₂: Thresholds
T: Number of iterations
  Initialize:
I⁰: set of T₁ column indices of L chosen based on ƒ(L,l)
Iᵢ⁰: set of indices in I⁰ corresponding to class i, i = 1, 2, . . . , N.
Initial object class estimate C⁰ = arg maxᵢ∥L_{I}_{ᵢ}_{⁰}xᵢ∥₂, where xᵢ = L [symbol]
Initialize residue r⁰ = l − L_{I}_{_{C}}_{⁰⁰}x_{C}_{⁰}
  Iterate:
for t = 1 to T
Compute Iᵣₑₛ^{t-1}: set of T₂ column indices of L chosen based on ƒ(L,r^{t-1})
Merge I_{new}^{t} = I_{C}_{^{t−1}}^{t-1} ∪Iᵣₑₛ^{t-1}
Compute I^{t}: set of T₁ column indices of L chosen based on L [symbol]
Compute I [symbol] : set of indices in I^{t} corresponding to class i
Compute class scores s^{t} (i) = ∥L [symbol] xᵢ∥₂ for each object class
i = 1, 2, . . . , N, where xᵢ = L [symbol]
Object class estimate C^{t} = arg maxᵢ ∥L [symbol] xᵢ∥₂
Compute residue r^{t} = l − L [symbol] x_{C}_{^{t}}
Check stopping criteria
end for
  Stopping criteria:
$If \\ ( \begin{matrix}{C}^{t} = {C}^{t - 1} AND \\ {‖ {r}^{t} ‖}_{2} \leq {‖ {r}^{t - 1} ‖}_{2} AND \\ \frac{{\sum }_{i = 1}^{N} \vert {s}^{t} ( i ) - {s}^{t - 1} ( i ) \vert}{{\sum }_{i = 1}^{N} \vert {s}^{t - 1} ( i ) \vert} < {T}_{1}\end{matrix} )$ $OR$ $t = T ,$
then check object rejection criterion
else go to iteration step 1
  Object rejection criterion:
If g(s^{t},I^{t},L, l) < τ₂, where s^{t} = (s^{t}(1), s^{t}(2), . . . , s^{t}(N))
then reject test object
else output class C^{t} and stop [symbol]
indicates data missing or illegible when filed
```

### Static Object Classification Pseudocode Details

1. Static object classification is a special case of the moving object classification, where there is no motion of the object, and hence no motion library. We have only the object library (referred to as simply the library) and the object descriptors are simply feature vectors.
2. One possible implementation of f(L, l) is to compute the vector dot-products between each column of L and l (or r^{t-1} as the case may be), and then select those column indices corresponding to the highest correlations. The selected columns stacked together are now denoted as Lₗ, where l is used here to denote the appropriate set of indices referred to. Further Lₗ^{†} denotes the pseudoinverse of Lₗ.
3. Truncation parameters T₁ and T₂ are chosen appropriately depending on the application and Library L
4. One possible method of selecting l^{t} is to choose the feature vector indices corresponding to the largest amplitudes.
5. Next, among the identified feature vectors in l^{t}, only those that belong to a particular class are considered, and a score is computed for each class. The class with the highest score is declared as the current class estimate.
6. If there is no convergence behavior among the class estimates at successive iterations, and if t<T, then the iterations are continued. Note that only one possible convergence requirement is outlined in the stopping criteria given in the pseudocode, and any other suitable criteria are equally applicable.
7. When t=T iterations or there is convergence, the test object is checked if it should be rejected. This is done using the object rejection criterion. If the object is not to be rejected, then the current class is declared as the output. One possible implementation of the rejection criterion g(.) is a simple threshold based rejection. Other suitable rejection criteria are equally applicable. For example, one could carry out further iterations with different truncation parameters.
   The proposed method can be extended to cover cases where there are multiple (say p) observations of the test object (say, using multiple cameras); or multiple samples of a given test object (for example, multiple images of the test object); or the case with multiple libraries L₁, L₂, . . . , Lₚ.

What is claimed is:

1. A computer-implemented method for classification of moving objects, comprising:
inputting a moving object;
extracting an object descriptor and a motion descriptor from the inputted moving object;
identifying multiple initial candidate library object descriptors from an object library and a motion library using the extracted object descriptor and the extracted motion descriptor, and wherein the object library and motion library are formed from given object samples comprising known object classes;
identifying an initial object class estimate based on the identified multiple initial candidate library object descriptors;
computing an initial residue based on the extracted object descriptor and the identified multiple initial candidate library object descriptors associated with the initial object class estimate; and
iteratively identifying object class estimates and determining whether the object class estimates converge based on a stopping criterion.

2. The computer-implemented method of claim 1, wherein iteratively identifying the object class estimates and determining whether the object class estimates converge based on the stopping criterion comprises:
identifying a set of multiple candidate object descriptors from the object library based on a residue and the identified multiple candidate library object descriptors from a previous iteration;
computing scores for each object class based on the identified set of multiple candidate library object descriptors;
identifying an object class estimate with a highest score;
computing a residue based on the extracted object descriptor and the identified candidate library object descriptors associated with the identified object class estimate; and
determining whether the identified object class estimates converge based on the stopping criterion.

3. The computer-implemented method of claim 2, further comprising:
if the stopping criterion is satisfied, determining whether to reject the inputted moving object based on an object rejection criterion.

4. The computer-implemented method of claim 3, further comprising:
if the inputted object is not to be rejected, declaring the identified object class as an output object class.

5. The computer-implemented method of claim 1, further comprising:
authoring an object class by a user through addition of an object library and a motion library associated with the object class to existing object library and motion library, respectively.

6. The computer-implemented method of claim 5, further comprising:
determining whether the authored object class by the user is to be rejected;
if so, rejecting the authored object class and requesting the user for an alternate object class; and
if not, adding the object library and the motion library associated with the authored object class to the existing object library and motion library, respectively.

7. The computer-implemented method of claim 1, wherein the object descriptor and the motion descriptor are selected from the group comprising of features describing shape, size, color, temperature, motion, and intensity of the inputted moving object.

8. A system for classification of static objects and dynamic objects, comprising:
a processor;
memory coupled to the processor; wherein the memory includes a moving object classification module having instructions to:
input a moving object;
extract an object descriptor and a motion descriptor from the inputted moving object;
identify multiple initial candidate library object descriptors from an object library and a motion library using the extracted object descriptor and the extracted motion descriptor, and wherein the object library and motion library are formed from given object samples comprising known object classes;
identify an initial object class estimate based on the identified multiple initial candidate library object descriptors;
compute an initial residue based on the extracted object descriptor and the identified multiple initial candidate library object descriptors associated with the initial object class estimate; and
iteratively identify object class estimates and determine whether the object class estimates converge based on a stopping criterion.

9. The system of claim 8, wherein the moving object classification module has further instructions to determine whether to reject the inputted moving object based on an object rejection criterion if the stopping criterion is satisfied.

10. The system of claim 9, wherein the moving object classification module has further instructions to declare the identified object class as an output object class if the inputted object is not to be rejected.

11. The system of claim 10, wherein the moving object classification module has further instructions to author an object class by a user through addition of an object library and a motion library associated with the object class to existing object library and motion library, respectively.

12. The system of claim 11, wherein the moving object classification module has further instructions to determine whether the authored object class by the user is to be rejected, to reject the authored object class and request the user for an alternate object class if it is determined so, and to add the object library and the motion library associated with the authored object class to the existing object library and motion library, respectively if it is determined not.

13. A non-transitory computer readable storage medium for classification of moving objects having instructions that, when executed by a computing device causes the computing device to:
input a moving object;
extract an object descriptor and a motion descriptor from the inputted moving object;
identify multiple initial candidate library object descriptors from an object library and a motion library using the extracted object descriptor and the extracted motion descriptor, and wherein the object library and motion library are formed from given object samples comprising known object classes;
identify an initial object class estimate based on the identified multiple initial candidate library object descriptors;
compute an initial residue based on the extracted object descriptor and the identified multiple initial candidate library object descriptors associated with the initial object class estimate; and
iteratively identify object class estimates and determining whether the object class estimates converge based on a stopping criterion.

14. The non-transitory computer readable storage medium of claim 13, further comprising instructions to author an object class by a user through addition of an object library and a motion library associated with the object class to existing object library and motion library, respectively.

15. The non-transitory computer readable storage medium of claim 14, wherein the object descriptor and the motion descriptor are selected from the group comprising of features describing shape, size, color, temperature, motion, and intensity of the inputted moving object.
